(19) United States
(12) Patent Application Publication
(10) Pub. No.: US 2012/0003981 A1
(43) Pub. Date: Jan. 5, 2012

(54) Signaling Femto-Cell Deployment Attributes to Assist Interference Mitigation in Heterogeneous Networks

(75) Inventors: Sandeep H. Krishnamurthy, Arlington Heights, IL (US); Michael E. Buckley, Grayslake, IL (US); Murali Narasimha, Lake Zurich, IL (US)

(73) Assignee: MOTOROLA, INC., Schaumburg, IL (US)

(21) Appl. No.: 12/829,534

(22) Filed: Jul. 2, 2010

(51) Int. Cl. H04W 72/04

(52) U.S. Cl. 455/450

(57) ABSTRACT

There are disclosed methods of a wireless communication device and a wireless base station. The device is served by a serving base station and receives from a neighbor base station a downlink transmission including a broadcast signal. The device decodes the broadcast signal, and determines a bandwidth attribute associated with the neighbor base station based on the broadcast signal. The device then sends to the serving base station a report including the bandwidth attribute associated with the neighbor base station. The wireless base station receives from a first wireless terminal a signal including a bandwidth attribute associated with a neighbor base station. The base station then schedules a second wireless terminal based on the bandwidth attribute of the neighbor base station, in which the first wireless terminal may be identical to the second wireless terminal.

### FIELD OF THE DISCLOSURE

The present disclosure relates to spectral efficiency optimization via interference control and mitigation in heterogeneous networks comprising macro-cells and home-base stations or femto-cells.

### BACKGROUND

Some wireless communication networks are completely proprietary, while others are subject to one or more standards to allow various vendors to manufacture equipment for a common system. One standards-based network is the Universal Mobile Telecommunications System (UMTS), which is standardized by the Third Generation Partnership Project (3GPP). 3GPP is a collaboration among groups of telecommunications associations to make a globally applicable third generation (3G) mobile phone system specification within the scope of the International Mobile Telecommunications-2000 project of the International Telecommunication Union (ITU). The UMTS standard is evolving and is typically referred to as UMTS Long Term Evolution (LTE) or Evolved UMTS Terrestrial Radio Access (E-UTRA).

According to Release 8 of the E-UTRA or LTE standard or specification, downlink communications from a base station (referred to as an “enhanced Node-B” or simply “eNB”) to a wireless communication device (referred to as “user equipment” or “UE”) utilize orthogonal frequency division multiplexing (OFDM). In OFDM, orthogonal subcarriers are modulated with a digital stream, which may include data, control information, or other information, so as to form a set of OFDM symbols. The subcarriers may be contiguous or non-contiguous and the downlink data modulation may be performed using quadrature phase shift-keying (QPSK), 16-ary quadrature amplitude modulation (16QAM), or 64QAM. The OFDM symbols are configured into a downlink sub frame for transmission from the base station. Each OFDM symbol has a time duration and is associated with a cyclic prefix (CP). A cyclic prefix is essentially a guard period between successive OFDM symbols in a sub frame. According to the E-UTRA specification, a normal cyclic prefix is about five (5) microseconds and an extended cyclic prefix is about 16.67 microseconds. The data from the serving base station is transmitted on physical downlink shared channel (PDSCH) and the control information is signaled on physical downlink control channel (PDCCH).

In contrast to the downlink, uplink communications from the UE to the eNB utilize single-carrier frequency division multiple access (SC-FDMA) according to the E-UTRA standard. In SC-FDMA, block transmission of QAM data symbols is performed by first discrete Fourier transform (DFT)-spreading (or precoding) followed by subcarrier mapping to a conventional OFDM modulator. The use of DFT precoding allows a moderate cubic metric/peak-to-average power ratio (PAPR) leading to reduced cost, size and power consumption of the UE power amplifier. In accordance with SC-FDMA, each subcarrier used for uplink transmission includes information for all the transmitted modulated signals, with the input data stream being spread over them. The data transmission in the uplink is controlled by the eNB, involving transmission of scheduling grants (and scheduling information) sent via downlink control channels. Scheduling grants for uplink transmissions are provided by the eNB on the downlink and include, among other things, a resource allocation (e.g., a resource block size per one millisecond (ms) interval) and an identification of the modulation to be used for the uplink transmissions. With the addition of higher-order modulation and adaptive modulation and coding (AMC), large spectral efficiency is possible by scheduling users with favorable channel conditions. The UE transmits data on the physical uplink shared channel (PUSCH). The physical control information is transmitted by the UE on the physical uplink control channel (PUCCH).

E-UTRA systems also facilitate the use of multiple input and multiple output (MIMO) antenna systems on the downlink to increase capacity. As is known, MIMO antenna systems are employed at the eNB through use of multiple transmit antennas and at the UE through use of multiple receive antennas. A UE may rely on a pilot or reference symbol (RS) sent from the eNB for channel estimation, subsequent data demodulation, and link quality measurement for reporting. The link quality measurements for feedback may include such spatial parameters as rank indicator, or the number of data streams sent on the same resources; precoding matrix index (PMI); and coding parameters, such as a modulation and coding scheme (MCS) or a channel quality indicator (CQI). For example, if a UE determines that the link can support a rank greater than one, it may report multiple CQI values (e.g., two CQI values when rank=2). Further, the link quality measurements may be reported on a periodic or aperiodic basis, as instructed by an eNB, in one of the supported feedback modes. The reports may include wideband or subband frequency selective information of the parameters. The eNB may use the rank information, the CQI, and other parameters, such as uplink quality information, to serve the UE on the uplink and downlink channels.

Home-base stations or femto-cells are referred to as Home-eNBs (HeNBs) in the sequel. A HeNB can either belong to a closed subscriber group (CSG) or can be an open-access cell. A CSG is set of one or more cells that allows access only to certain group of subscribers. HeNB deployments where at least a part of the deployed bandwidth (BW) is shared with macro-cells are considered to be high-risk scenarios from an interference point-of-view. When UEs connected to a macro-cell roam close to a HeNB, the uplink of the HeNB can be severely interfered with particularly when the HeNB is far away (for example >400 m) from the macro-cell, thereby, degrading the quality of service of UEs connected to the HeNB. Currently, the existing Rel-8 UE measurement framework can be made use of identify the situation when this interference might occur and the network can handover the UE to an inter-frequency carrier which is not shared between macro-cells and HeNBs to mitigate this problem. However, there might not be any such carriers available in certain networks to handover the UE to. Further, as the penetration of HeNBs increases, being able to efficiently operate HeNBs on the entire available spectrum might be desirable from a cost perspective.

In this disclosure, we discuss HeNB uplink (UL) interference and downlink (DL) interference problems in further detail and propose a method that can enable a more effective co-channel/shared channel deployment of HeNBs in LTE Rel-9 systems and beyond.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the one or more embodiments of the present invention.

FIG. 1 shows a schematic diagram with macro-cell and a home-base station in the macro-cell's coverage area, in accordance with the present invention.

FIG. 2 shows a schematic diagram with macro-cell and a home-base station in the macro-cell's coverage area, in accordance with the present invention.

FIG. 3 illustrates a diagram showing the bandwidth arrangement in E-UTRA network (E-UTRAN) downlink.

FIG. 4 shows a diagram indicating the bandwidth arrangement on the uplink of a heterogeneous network, in accordance with the present invention.

FIG. 5 is a logic flow diagram of steps executed by a wireless communication device to process a downlink transmission from a neighbor base station and decode the transmission attributes of that base station and further signaling of the decoded attributes to the serving base station, in accordance with the present invention.

FIGS. 6 and 7 show flow diagrams of the steps executed by a base station making use of the reports containing bandwidth attributes corresponding to a neighbor base station in scheduling its users to mitigate the DL/UL interference problem, in accordance with the present invention.

### DETAILED DESCRIPTION

There are disclosed methods of a wireless communication device and a wireless base station. The device is served by a serving base station and receives from a neighbor base station a downlink transmission including a broadcast signal. The device decodes the broadcast signal, and determines a bandwidth attribute associated with the neighbor base station based on the broadcast signal. The device then sends to the serving base station a report including the bandwidth attribute associated with the neighbor base station. The wireless base station receives from a first wireless terminal a signal including a bandwidth attribute associated with a neighbor base station. The base station then schedules a second wireless terminal based on the bandwidth attribute of the neighbor base station, in which the first wireless terminal may be identical to the second wireless terminal.

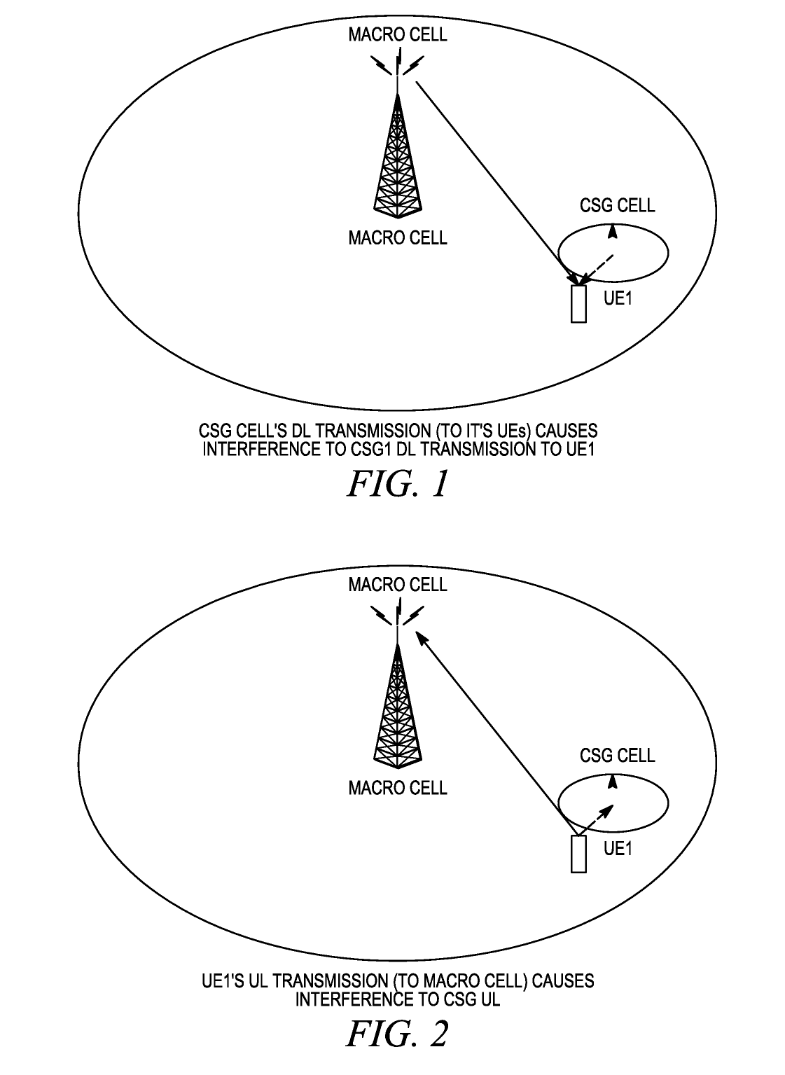

In a heterogeneous network comprising macro cells and HeNBs cells that have overlapping bandwidth (BW) deployments, certain interference problems can arise. One such interference problem is depicted in FIG. 1, where the uplink (UL) transmission from a UE connected to a macro-eNB (MeNB) that is close to (i.e., within signal range of a HeNB) severely interferes with the UL of a UE connected to the HeNB. This case has been identified as interference scenario 3 in 3GPP TR 25.967 “Home Node B Radio Frequency (RF) Requirements (FDD) (Release 9)” in Universal Terrestrial Radio Access (UTRA) network.

The severity of the problem can be quite high when the separation between MeNB and the HeNB is large. This is illustrated by some simple calculations as follows. The pathloss (PL) equation for typical macro-cellular environments (from TR 25.814) used in system evaluations is given by PL (dBm)=128.1+37.6 log₁₀(R), where R is in kilometers, for 2 GHz carrier frequency. The MUE sets it UL transmit power based on the receiver SINR requirement at the MeNB that is further dependent on the desired PUSCH MCS. From TS 36.213, the UL power control equation can be approximated as P_{Tx,MUE}=max{P_{CMAX}, I_{MeNB}+SNR_{req,MeNB}+PL_{MeNB-MUE}}, where P_{CMAX} is the maximum allowed MUE transmit power per the power class, I_{MeNB} is the co-channel interference at the MeNB receiver, SNR_{req,MeNB} is the required SINR for MUE UL transmission to support the desired MCS level and PL_{MeNB-MUE} is the patloss from the MeNB to the MUE.

Table 1 summarizes the dependence on distance of PL and MUE transmit power with P_{CMAX}=23 dBm, I_{MeNB}=−98 dBm and SNR_{req,MeNB}=10 dB.

TABLE 1
PL and MUE transmit power dependence on distance

| MeNB-MUE | PL_{MeNB-ME} | P_{Tx,MUE} |
|---|---|---|
| distance (m) | (dB) | (dBm) |
| 100 | 90.40 | 2.40 |
| 200 | 101.72 | 13.72 |
| 300 | 108.34 | 20.34 |
| 400 | 113.04 | 23.00 |
| 500 | 116.68 | 23.00 |
| 600 | 119.66 | 23.00 |
| 700 | 122.18 | 23.00 |
| 800 | 124.36 | 23.00 |
| 900 | 126.28 | 23.00 |
| 1000 | 128.00 | 23.00 |

From these calculations, a MUE further away from MeNB than 400 m starts transmitting at maximum power under the chosen conditions. For a macro-cell with 1 km cell radius, this means that roughly 80% of users are transmitting at maximum power. Therefore, a MUE that roams close to a HeNB serving its users can severely degrade the UL throughput in the HeNB particularly when the MeNB-HeNB separation becomes large (>400 m).

Techniques such as adaptive uplink attenuation considered in the UTRA-framework 3GPP TR 25.967 are likely to be investigated in the LTE context for mitigating this problem. However, this alone might not be sufficient in achieving the best spectral efficiency possible with heterogeneous deployments. In the sequel, we discuss some further methods that can be useful in making HeNB deployments more efficient.

A coarse geolocation of UEs is possible by thresholding either the pathloss (PL) of the UE from a HeNB or alternately, thresholding the differential pathloss between HeNB and MeNB. In one embodiment, if the PL(HeNB to UE) is below a pre-determined threshold, then the UE is close HeNB. In an alternate embodiment, if the difference (PL(MeNB to UE)−PL(HeNB to UE)) exceeds a certain threshold, then the UE is not only close to the HeNB, but it can pose a significant interference risk to the UL of the HeNB. If a macro-cell UE that is far away from the macro-cell but near a CSG cell transmits with large power, it can cause UL interference to CSG UEs. For determining the pathloss from the HeNB to the UE, the UE can read the system information broadcast (SIB) containing information element pertaining to the downlink transmit power of the HeNB. Alternately, it can make some assumptions on the downlink transmit power (eg. set it to maximum allowed power per the power class of HeNBs deployed in the network).

In 3GPP TR 25.967, deployments leading to partial BW overlap on the downlink (DL) as shown in FIG. 2 have been considered. In Rel-9, it is likely that there will be HeNB deployments where the HeNB UL bandwidth only has a partial overlap with the macro-cell UL bandwidth. The following scenarios where partial overlap occurs can be envisaged.

a. The UL bandwidth of a HeNB is not equal to the UL bandwidth of the macro-cells.

b. Fractional frequency reuse (which is being investigated) where a certain HeNB may use only a portion of the available bandwidth configured semi-statically or dynamically is enabled.

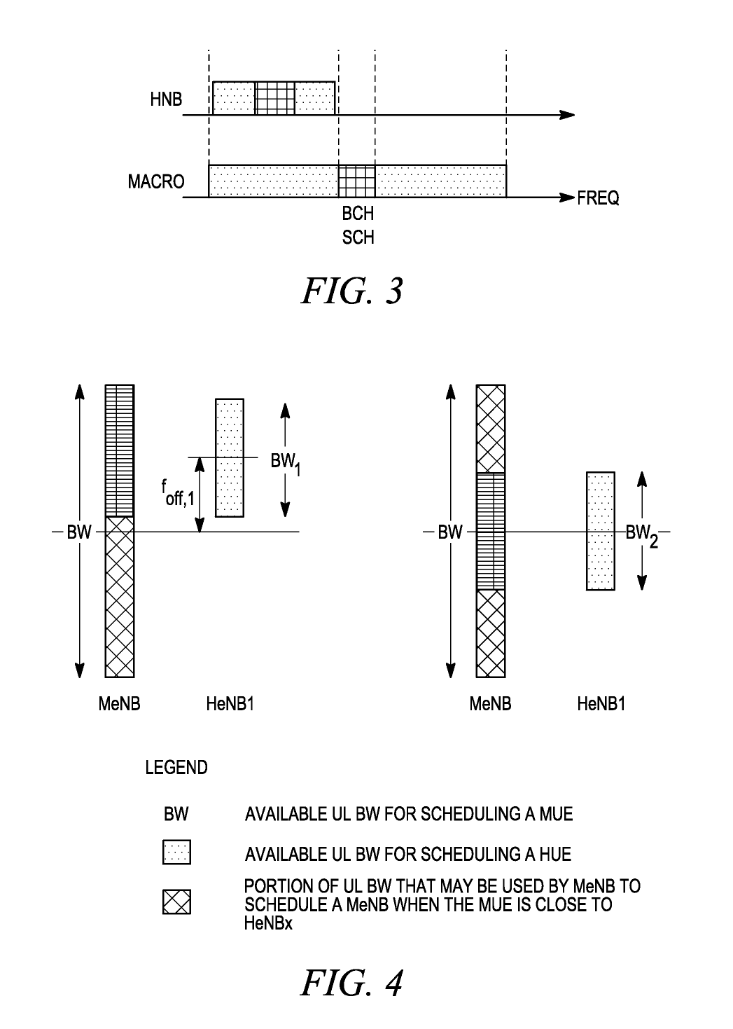

FIG. 3 shows a potential UL BW arrangement for two example cases. In Case 1, the HeNB carrier on the UL is offset relative to the MeNB UL carrier. In Case 2, the HeNB and MeNB share the same carrier. In both cases, the HeNB UL overlaps with only a part of the MeNB UL. This means that, if a MUE were to roam close to a HeNB, then the UL interference from MUE to HeNB can be mitigated by scheduling PUSCH RBs for the MUE outside of the bandwidth used in HeNB UL. This is feasible if the MeNB has information pertaining to
the UL carrier frequency of the HeNB or alternately, the carrier offset of the HeNB from the MeNB carrier, and
the UL BW configured by the HeNB.

In a similar manner, in LTE Rel-9 and beyond, it is likely that there will be HeNB deployments where the HeNB DL bandwidth only has a partial overlap with the macro-cell DL bandwidth. The following scenarios where partial overlap occurs can be envisaged.
a. The center frequency of the HeNB is offset by at least 6 PRBs from the macro-cell frequency layers, but with overlapping bandwidths as shown in FIG. 2. The offset is enabled to avoid MeNB-HeNB interference on synchronization channel (SCH) and/or Master Information Block (MIB).
b. The DL bandwidth of a HeNB is not equal to the DL bandwidth of the macro-cells.
c. Fractional frequency reuse (which is being investigated) where a certain HeNB may use only a portion of the available bandwidth configured semi-statically or dynamically is enabled.

The BWs supported by Rel-8 eNBs are typically from the set {1.4 MHz, 3 MHz, 5 MHz, 10 MHz, 20 MHz}, while the BWs for CSG cells (HeNBs) will likely be from the set {5 MHz, 10 MHz}. Suppose that the BW of the deployed homogenous network is 10 MHz and there could be a number of 5 MHz or 10 MHz HeNBs sharing (at least a part of) the BW. The HeNB carrier can be offset relative to the macro-cells and these offsets could be different for different HeNBs. The network may have access to the raster of carriers on which HeNBs in an geographical location are situated on but the network (NW) operations and management (O&M) otherwise has limited knowledge of whether at a given point in time HeNBs are serving on a certain carrier frequency or not. This is because the HeNB deployments are intended to be uncoordinated. Further, it is possible that a HeNB powers up at some arbitrary instant in time without the MeNBs knowing about it for the same reason. Whether or not
a certain UE connected to a MeNB can be interfered on the DL by a HeNB, or
a certain UE (aggressor) can interfere with HeNB UL (victim)
   depends on the location of the UE in the macro-cell and its proximity to the HeNB. In order to identify when such problems can occur, the UE can be asked by the serving macro-cell to scan the raster on which HeNBs could be present and identify cells within its range to report some attributes associated with the HeNB back to the serving base station. For example, in LTE Rel-8, the reporting of the pair physical cell identifier (PCID) and the reference signal received power (RSRP) is defined to enable measurements-based mobility. Towards this end, the UE needs to be able to detect the synchronization channel (SCH) and measure the power on the received cell-specific reference signal (CRS).

If the macro-cell that is serving the UE has knowledge of the transmission BW of the HeNB that the UE is close to both on the UL and DL, it can deduce the part of the BW it can use that is not occupied by any of the CSG cells in the range of a given UE. This frequency region can then be used for DL/UL scheduling of the UE by the macro-cell avoiding DL/UL interference from and to the CSG cell DL/UL respectively.

In order to support the UL coordination outlined in the previous section for mitigating MUE interference to HeNB UL, some additional UE measurements are necessary for the following reasons.
Asymmetric DL/UL deployments are likely (eg. 10 MHz DL and 5 MHz UL, etc.) in typical HeNB deployments. Also, it is possible that a single network has HeNBs with different BW capabilities.
Variable UL/DL separation is not only useful to deploy certain interference mitigation techniques (eg. DL carrier offset avoidance of MeNB-HeNB interference of SCH/MIB channels, frequency reuse, etc.) but, might be necessary if carrier aggregation is enabled. Therefore, different UL/DL separations than that in Rel-8 are likely in the future.
The operator has knowledge of the E-UTRA Absolute Frequency Channel Number (EARFCN) raster on which the HeNBs are allowed to deploy in a give band. But, in a network, whether or not a MUE poses an UL interference problem to a HeNB is based on how far away the MUE is from the MeNB and how close it is to a HeNB.

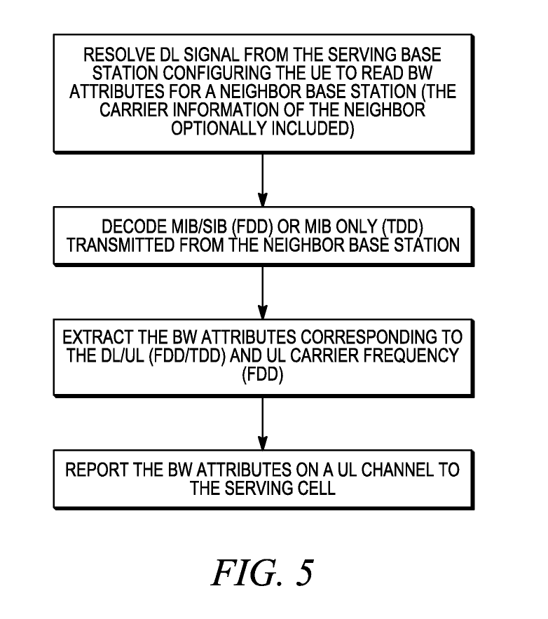

FIG. 5 shows a flow chart corresponding to an embodiment. The main steps of UE processing are outlined. In the embodiment, the UE can read the master information block (MIB) and/or system information broadcast (SIB) transmitted from the HeNBs, it can determine the DL BW of the HeNB, the UL carrier frequency information (in FDD systems, the DL and UL carrier are different) and the DL/UL carrier frequency separation (in TDD systems, the UL and DL carriers are the same—therefore, the DL/UL carrier separation is not defined). After determination of one or more of these quantities, the UE can report these transmission parameters corresponding to the HeNB. These parameters can be signaled on the UL together with at least one of the PCID of the HeNB and RSRP of the HeNB measured at the UE. In an alternate embodiment, the UE can process the basic information decoded from MIB and/or SIB and then signal functions derived from these quantities. For example, one or more of the quantities PCID, DL BW, UL BW, UL carrier frequency and DL/UL duplexer separation can be included in the report sent by the UE on the UL. Alternately, the common resource block (RB) space in frequency-domain used by one or more HeNBs within range can be determined and signaled. For example, the report may include the pair (RB lower end index, RB upper end index) or alternately (RB lower end, number of RBs used on UL). The RB indexing can be relative to the macro-cell RB numbering and this information can be signaled separately for both DL and UL.

In the embodiment, the UE has the capability to perform the following actions in a FDD deployment.

1. Read MIB transmission from a HeNB and determine the DL bandwidth (dl-Bandwidth),
2. Read SIB transmissions from a HeNB and determine
a. UL carrier frequency (for example, ul-CarrierFreq information element defined in TS 36.331), and
b. UL bandwidth (for example, ul-Bandwidth information element defined in TS 36.331)

In the embodiment, the UE has the capability to perform the following actions in a TDD deployment.

1. Read MIB transmission from a HeNB and determine the common UL/DL bandwidth (dl-Bandwidth).

The UE can report the UL/DL/carrier attributes relating the UL/DL transmission in the HeNB to the serving MeNB on the UL. The information may be transmitted in a radio resource control (RRC) report or some other uplink control signalling.

In the embodiment, if the carrier frequency on which HeNBs are situated are not the same as the serving MeNB carrier, then the serving base station may configure a measurement gap to allow for the UE to tune its radio frequency (RF) oscillator to the relevant inter-frequency carrier. If the HeNB BW is completely contained within the MeNB BW and the frequency offset between the MeNB and the HeNB carriers are integer multiples of one OFDM subcarrier (eg. 15 kHz in LTE), then provisioning of gaps might not be necessary. This also applies to the case when the MeNB and HeNB share the same carrier frequency.

If the frame timing of the MeNB and HeNB are not aligned, the UE can additionally detect and report the frame timing difference between the MeNB and the HeNB.

The list of candidate carrier frequencies on which HeNBs are allowed to operate on within a given band are known to the network operator. There are many way such a list can be signalled. In one embodiment, the EARFCN of the raster frequencies can be signalled. In another embodiment, the range of EARFCN can be signalled. In an alternative embodiment, the list can be signalled implicitly by indicating that the UE scan all of the raster frequencies (with 100 kHz separation in LTE) within the operating bandwidth of the MeNB.

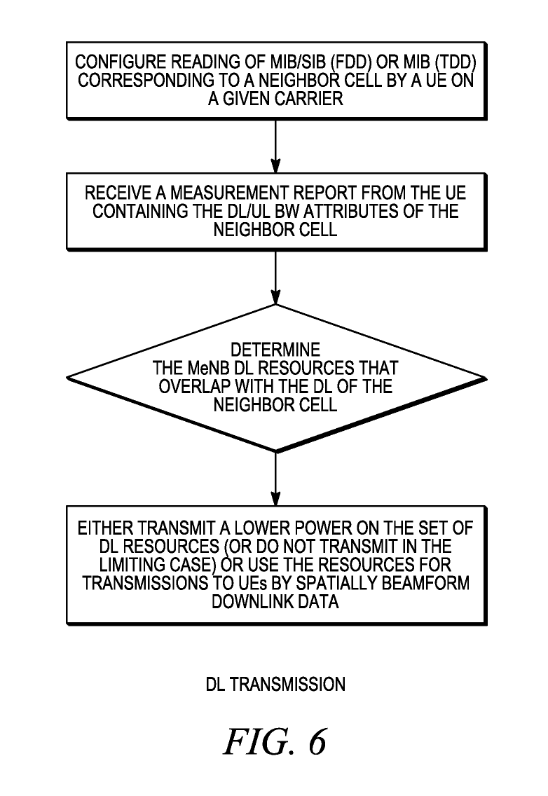

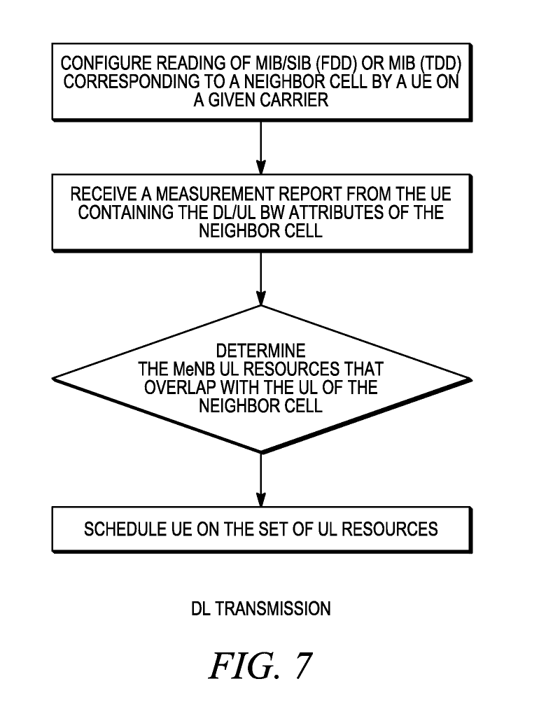

FIGS. 6 and 7 illustrate flow charts outlining steps that a MeNB may carry out making use of the information reported by the UE according to the embodiment. The information reported in the embodiment relating to the UL/DL BW attributes of the HeNB can provide a MeNB with sufficient capability to mitigate both DL and UL problems in heterogeneous deployments. With the knowledge of the DL BW of the HeNB there are at least two ways a MeNB may be able to mitigate interference on the DL. The first method involves identification of the set of resources available DL scheduling on PDSCH of MeNB that overlaps with the HeNB DL. The set of resources can be one or more RBs. The MeNB can either not schedule any user on those resources to avoid interfering with the HeNB DL. Alternately, the MeNB can transmit on those resources at lower power than the maximum base station transmit power to reduce the interference it causes on the HeNB DL. Since, the resources are orthogonal in frequency, the MUE that roams close to the HeNB does not experience interference from the HeNB DL transmission. In this alternative, those resources may be used to serve only those UEs that are close to the MeNB and consequently require a lower transmit power. The second method also involves identification of resources available on the MeNB DL that overlap with HeNB transmission. The MeNB uses spatial interference mitigation techniques (for example, beamforming with dedicated reference signal or DRS-based scheduling) to point the beam at the MUE being served thereby, avoiding interference to a UE connected to the HeNB.

The information reported in the embodiment relating to the UL BW/UL carrier attributes of the HeNB can provide a MeNB with sufficient capability to mitigate UL interference problems in heterogeneous deployments. Several methods are possible. In one method, the MeNB can identify the set of resources available for scheduling users on the UL that do not overlap with the resources used by HeNB for its users on its UL. The resources can correspond to resource blocks (RBs) available for transmission on the PUSCH. The MeNB can allocate UL resources to a MUE such that the MUE avoids interfering with a nearby HeNB on its UL by scheduling on non-overlapping resources.

As discussed earlier, the additional UE reporting equips the marco-eNB with the necessary information to perform PUSCH scheduling that does not interfere with HeNB data and control on the uplink. Clearly, this approach can bring large gains to HeNB performance However, there is a potential for some throughput loss on the MeNB uplink due to reduced transmission resources. There is, therefore, a trade-off between macro-eNB and HeNB performances.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device, the device being served by a serving base station, the method comprising:
receiving from a neighbor base station a downlink transmission including a broadcast signal;
decoding the broadcast signal;
determining a bandwidth attribute associated with the neighbor base station based on the broadcast signal; and
sending to the serving base station a report including the bandwidth attribute associated with the neighbor base station.

2. The method according to claim 1, further comprising receiving a resource allocation assigning a resource non-overlapping with a bandwidth corresponding to the bandwidth attribute.

3. The method of claim 1, wherein the broadcast signal includes a master information block.

4. The method of claim 1, wherein the broadcast signal includes a system information block.

5. The method of claim 1, wherein the bandwidth attribute includes at least one of a downlink bandwidth, an uplink bandwidth, an uplink carrier frequency, or a downlink carrier frequency of the neighbor base station.

6. The method of claim 1, further comprising receiving a configuration message from the serving base station including at least one of a physical cell identity of a neighbor base station or a downlink carrier frequency of a neighbor base station.

7. The method of claim 1, further comprising receiving the broadcast signal from the neighbor base station during a transmission gap configured by the serving base station.

8. The method of claim 1, further comprising receiving a configuration message from the serving base station, the configuration message including information associated with a list of carrier frequencies available to one or more neighbor base stations.

9. A method of a wireless base station comprising:
receiving from a first wireless terminal a signal including a bandwidth attribute associated with a neighbor base station; and
scheduling a second wireless terminal based on the bandwidth attribute of the neighbor base station, wherein the first wireless terminal may be identical to the second wireless terminal.

10. The method of claim 9, wherein the bandwidth attribute includes at least one of a downlink bandwidth, an uplink bandwidth, an uplink carrier frequency, or a downlink carrier frequency of the neighbor base station.

11. The method of claim 9, further comprising:
determining a set of transmission resources used on a downlink of the neighbor base station; and
transmitting data to at least the second wireless terminal on a set of resource blocks based on a dedicated reference signal transmission.

12. The method of claim 9, further comprising:
determining a set of transmission resources unused on a downlink of the neighbor base station; and
transmitting data to at least the second wireless terminal using a resource unused on the downlink of the neighbor base station.

13. The method of claim 9, further comprising:
determining a set of transmission resources unused on an uplink of the neighbor base station; and
scheduling data transmission from the wireless terminal within the set of transmission resources.
